(19) United States
(12) Patent Application Publication
(10) Pub. No.: US 2001/0034635 A1
(43) Pub. Date: Oct. 25, 2001

(54) System and method for utilizing a fully-integrated, on-line digital collectible award redemption and instant win program

(76) Inventor: Gil Winters, Marietta, GA (US)

Correspondence Address: KING & SPALDING, 191 PEACHTREE STREET, N.E., ATLANTA, GA, 30303-1763, US

(21) Appl. No.: 09/771,501

(22) Filed: Jan. 26, 2001

Related U.S. Application Data
(60) Provisional application No. 60/178,149, filed on Jan. 26, 2000.

(51) Int. Cl. G06F 17/60

(52) U.S. Cl. 705/10

(57) ABSTRACT

A fully integrated, on-line digital collectible award redemption and instant-win program is disclosed. Consumers will receive Limited Edition Digital Objects (LEDOs) from online merchants and websites as a premium for making online purchases, visiting their websites, or doing other activities such as taking surveys, signing up for memberships, etc. LEDOs will be represented on users' computer and TV screens as small images that can be collected and organized in an on-screen viewing album. When activated, LEDOs can show pictures, play sounds and movies, and be used for a variety of interactive entertainment, including instant win contests, and as game pieces for video and online games. As for any collectible, key to the appeal of LEDOs is that they are organized into lines of content that appeals to the passions, interests, and lifestyles of consumers. Utilizing the present invention, LEDOs can also be saved as redemption points, and can be traded in for redemption award. Consumers as well as on-line websites will be able to recruit new users of LEDOs, and will be compensated for their recruiting efforts on an ongoing basis relative to the number of new LEDOs their recruits acquire. This compensation can take the form of monetary awards or the award of additional LEDOs. In addition, a central data processing system, accessed through “online” networks of computers, will provide consumers with a “shopping portal” to find goods and services available at participating merchants and websites that will in award LEDOs to users in return, a catalog showroom of redemption merchandise, and the ability to interact with other LEDO collectors in games, chat, auctions, and trading.

### RELATED APPLICATION

This application claims priority to U.S. provisional patent application, Ser. No. 60/178,149, filed Jan., 26, 2000, and incorporated by reference herein, pursuant to 35 U.S.C. § 119.

### TECHNICAL FIELD

The present invention generally relates to the use to an on-line premium program. More particularly, the present invention relates to an on-line, fully-integrated premium program based on digital collectibles that are interactive, that can be saved as redemption points, and that can be utilized as instant win games.

### BACKGROUND OF THE INVENTION

The Limited Edition Digital Object (LEDO) is a concept (and term) that originated in the computer games industry for collectible game pieces to be used in on-line computer games. One of the key aspects of the LEDO concept is that, although a LEDO is a digital computer file, a LEDO cannot be easily duplicated, and thus LEDOs take on the characteristics of collectibles. Computer game players buy “lots” (or “packs”) of LEDOs, sight unseen, for the purpose of having new computer game pieces that increase their game-playing options within the associated on-line games. For example, the player might acquire more “powerful” game pieces, or ones that are more interesting to the player, or both. The computer games associated with LEDOs are often complex, and therefore, appeal to a somewhat limited audience. Thus, prior art business methods for LEDOs in the computer games industry are based upon the concept of giving new players a small amount of LEDOs so that the new players are allowed to trial a particular game. Thereafter, the new players are allowed to continue playing the particular game as often as they wish, at no cost to the new player. The only time players incur additional costs is when they desire to purchase additional LEDOs for use with the particular game.

While compelling for an audience of on-line game players, the disadvantage with this prior art use of LEDO technology is the extremely small size of the market to which this business method appeals. Also, mass audiences to date have become accustomed to high quality, on-line entertainment being provided without cost to consumers. As a result, there is a need in the art for a business method that provides a mass audience for LEDO technology and that allows for better opportunities for creating revenues based upon the use of LEDOs. The present invention meets these needs through a novel combination of LEDO technology with certain aspects of other prior art business methods, which are discussed below.

In that regard, the travel industry and others have developed business methods known as “frequency programs” to promote customer loyalty. An example of such a business method is an airlines-based “frequent flyer” program. In addition, this prior art business method has been replicated on the Internet by Internet redemption point companies, who award “miles” or “points” to participants for consumer behaviors such as buying goods and services from participating merchant partners, visiting partner websites, taking surveys, and signing up for memberships with partner companies. When a participant accumulates a sufficient number of miles or points, the participant may redeem the points for an award chosen from lists that are typically displayed on the Internet redemption point company's website.

While inducing customer loyalty, these traditional and on-line redemption point programs have the disadvantage of providing no immediate value to participants until and unless they are able to amass a large number of points. Additionally, such programs offer very little, if any, immediate entertainment value or instant gratification. Finally, such programs, when developed by third party providers, must compete directly with similar loyalty programs that a third party's potential merchant partners have implemented directly. Thus, there is a need in the art for a business method that induces customer loyalty, but that provides more immediate entertainment value and/or instant gratification to participants and provides a unique redemption method that does not directly compete with the pre-existing redemption programs.

Also, “instant win” games, sweepstakes, lotteries, and other types of prize-based contests/games of chance have been in existence for many years, and have broad appeal to mass markets of consumers, as they offer instant gratification, “fan”, and a chance to win prizes. However, such business methods have faced legal challenges on the Internet due to the myriad laws pertaining to on-line gambling. As a result, they are often too inconvenient for most on-line merchants, despite their strength in off-line marketing promotions.

Additionally, “multi-level marketing” or “affiliate marketing” business methods also have been in use for many years and have been highly successful in the off-line world. However, many of these systems are based on personal, “face-to-face” relationships and contacts, which do not typically exist in the on-line consumer experience. In addition, such business methods have become associated with “aggressive” sales techniques and are shunned by many consumers. Thus, there is a need in the art for a business method that utilizes the successful aspects of multi-level marketing in the absence of personal contacts, while avoiding negative consumer reactions to such business methods.

Successful industries have also existed for many years in the areas of collectibles, i.e., antiques, trading cards, toys, etc., and in the area of the sale of “licensed properties”, i.e., official sports and entertainment merchandise. However, these industries do not provide for a method of producing “indirect” revenues that are not directly tied to the sale/trade of the actual collectible or licensed merchandise. Thus, there is a need in the art for a business method that will utilize the successful aspects of the collectibles and licensed properties industries, which will also provide a method for producing additional, “indirect” revenue streams.

All of these business methods and industries have been affected by the rise of the use of the Internet, which is a grossly compelling phenomenon. Millions of websites allow users to learn about virtually any subject, buy virtually any good or service, perform research, meet people and/or be diverted/entertained for hours on end. However, the disadvantage that many “content” websites have experienced is that although they are effective in attracting audiences, they often have difficulty extracting revenue from their visitors, who have grown accustomed to the idea that Internet “content” is free. In addition, the disadvantage many commerce-based websites have experienced is that they must expend large amounts of resources on marketing and advertising because to compete with their “bricks-and-mortar” counterparts and other Internet-based businesses that sell the same products. Commerce-based websites have the additional disadvantage of competing with content websites for the attention of customers, who often find content websites more compelling.

As noted above, there is a clear need in the art for a business method that utilizes the many successful aspects of prior art on-line and off-line premium programs. There is a further need for such a system that provides the ability of overcoming the unique challenges of creating revenues and customer loyalty in the on-line environment.

### SUMMARY OF THE INVENTION

The present invention solves the aforementioned problems existing in the prior art by providing a system and method for utilizing an on-line, fully-integrated, interactive premium program that combines the best aspects of LEDO technology, off-line and on-line redemption point programs, instant win and other types of prize-based games of chance, multi-level marketing methods and of the collectibles and licensed properties industries. The present invention provides this functionality in a way that allows content websites to extract value from the audiences they attract and allows commerce websites to attract and retain customers in a way that is cost-efficient and in a way that takes advantage of the personal interests and passions of Internet audiences. This functionality is provided in part by the use of LEDOs that are created to focus on the personal interests and passions. Examples of such areas of interest are music, movies, sports, celebrities, history, nature/outdoors activities, hobbies, etc.

The present invention allows commerce websites providers to award LEDOs to their customers by notifying a LEDO provider electronically who their customers are, and how many LEDOs have been awarded to particular customers. An advantage of the present invention is that the merchant partners do not have to pre-purchase LEDOs or track LEDOs within their inventory system, nor do they have to track the various areas of interest, or content lines, for which LEDOs are available. Rather, merchant partners only pay a referral fee, typically equal to a percentage of a sale of goods connected with the use of LEDOs, after the sale is made. Through the use of a fully-integrated, central data processing system, the present invention can handle the award and tracking of LEDOs to customers.

Another advantage of the present invention is that it allows content websites providers simply to register with a LEDO provider, to make certain minor additions/changes to their existing website, and consequently to increase their revenues from visitors to their website in a way that visitors to the website will likely find appealing based on their personal interests and passions. Typically, the minor additions/changes a content websites provider will make to their existing websites will consist of adding banners/text/images that provide their visitors with information on receiving and/or using no-cost LEDOs that are related to the content of the particular website. Thus, visitors who “click” on these banners/text/images will gain the opportunity to register with a LEDO provider to receive LEDOs at no cost. In addition, a visitor may be “keyed” to the content website as his recruiter during the registration process. Over time, as the visitor earns additional LEDOs from on-line shopping or other desired consumer behavior, a portion of the revenue generated by the use of the additional LEDOs may then be returned to the content website who initially recruited the consumer. A further advantage of the present invention is that LEDO users themselves may be allowed to recruit new LEDO users and receive compensation for such efforts. This aspect of the present invention will grow the ranks of LEDO users quickly and efficiently.

Another advantage of the present invention is that it provides a method by which LEDO technology may be exposed to and used by mass audiences by providing access to LEDOs to consumers at no cost, by making LEDOs more widely available on the Internet, by deriving value from the use of LEDO technology beyond the use of LEDOs as game pieces for the niche market of on-line games. Specifically, through the present invention, LEDOs may be provided as premiums at commerce and other websites, “advertised” at a host of content websites. As a result, LEDOs may attain value due to the fact that they are interactive, entertaining, collectible and tradable, they may be utilized as instant-win prizes, and they may be utilized as redemption points.

A further advantages of the method of present invention is the flexibility it provides to LEDO users. Specifically, LEDO users may choose what LEDO content line(s) they wish to collect and what denominations, i.e., what redemption value, of LEDOs they want to receive. In addition, users may be provided with collector albums and various other forums (e.g., “chat rooms”, auctions, on-line classified ads, on-line games) to interact/trade with other LEDO users. Also, LEDO users may be provided with a central on-line location to visit to obtain information and statistics related to collecting/trading LEDOs. In combination, these advantages allow for a novel user experience for collecting/trading LEDOs and may act to maximize the entertainment value of LEDO technology.

Another advantage of the present invention, is that it provides increased efficiency relative to prior art Internet redemption point business methods in that it may allow for lower redemption rates as some LEDO collectors may choose not to redeem LEDOs that achieve value as collectibles.

Another advantage of the present invention is that it allows for a lottery ticket or instant-win experience within a business method that may create indirect revenue streams without consumer cost, thus avoiding many regulatory issues concerning on-line gambling.

### BRIEF DESCRIPTION OF THE DRAWINGS

FIG. 1A is a functional block diagram illustrating the structure of the business method of an exemplary embodiment of the present invention.

FIG. 1B is a functional block diagram illustrating the structure of the on-line user experience utilizing an exemplary embodiment of the present invention.

FIG. 2A is an exemplary screen shot of a website utilizing the system and method of an exemplary embodiment of the present invention.

FIG. 2B is an exemplary screen shot of a webpage an exemplary embodiment of a LEDO to be utilized with an exemplary embodiment of the present invention.

FIG. 3 is a logic flow diagram illustrating a user access process of an exemplary embodiment of the present invention.

FIG. 4 is a logic flow diagram illustrating a user enrollment process of an exemplary embodiment of the present invention.

FIG. 5 is a logic flow diagram illustrating a process for viewing a user's LEDO collection utilizing an exemplary embodiment of the present invention.

FIG. 6A is a logic flow diagram illustrating a process for displaying LEDO content lines to users of an exemplary embodiment of the present invention.

FIG. 6B is a logic flow diagram illustrating a process for displaying redemption opportunities to users of an exemplary embodiment of the present invention.

FIG. 7 is a logic flow diagram illustrating a process for awarding LEDOs to users of an exemplary embodiment of the present invention.

FIG. 8 is a logic flow diagram illustrating a process for the purchase by and award to users of LEDOs of an exemplary embodiment of the present invention.

FIG. 9 is a logic flow diagram illustrating a process for a user to earn no-cost LEDOs by utilizing an exemplary embodiment of the present invention.

FIG. 10 is a logic flow diagram illustrating a product selection and on-line purchasing process utilizing an exemplary embodiment of the present invention.

FIG. 11 is a logic flow diagram illustrating a redemption process utilizing an exemplary embodiment of the present invention.

FIG. 12 is a logic flow diagram illustrating an entertainment and on-line gaming process of an exemplary embodiment of the present invention.

FIG. 13 is a logic flow diagram illustrating a trading/auction process utilizing an exemplary embodiment of the present invention.

FIG. 14 is a logic flow diagram illustrating an additional auction process utilizing an exemplary embodiment of the present invention.

### DETAILED DESCRIPTION OF THE EXEMPLARY EMBODIMENTS

The present invention provides a system and method for utilizing an on-line, fully-integrated premium program based on digital collectibles, i.e., LEDOs. The present invention also provides a novel system and method for utilizing LEDO technology and for creating indirect revenues from the use of licensed properties and content websites in connection with commerce websites.

Although the term “LEDO” is used herein, LEDO is an acronym for “Limited Edition Digital Object”. The LEDO concept exists as prior art, having been researched, developed, and/or marketed by at least the following companies: PostLinear (under the name “LEDO”), Digital Addiction (“Digital Toys”), Genetic Anomalies (“Collectible Bits”), IBM (“Cryptolopes”), and Thingworld (“Things”). The present invention is directed to a novel, non-obvious system and business method for utilizing LEDOs, regardless of the technological format of the digital objects, and to imbuing LEDOs with certain characteristics.

It should be further noted that in the sub-components of the exemplary system and method of the present invention described herein, a LEDO user may be allowed to navigate (or “surf”) between any particular point in the system. It will be appreciated by those skilled in the art that many of the sub-functions and sub-processes of the present invention, such as “searching” and “search engines” are mature technologies that are well understood, and are common practice for website providers. This being stated generally, it will be appreciated that such features and functions are incorporated into the disclosed exemplary embodiments, and will not be detailed where it could be reasonably expected that those skilled in the art would intuitively assume and/or understand such features and functions.

In addition, the exemplary embodiments described herein often describe websites, webpages, navigating processes, etc., as they would occur within an Internet browser (e.g., MICROSOFT INTERNET EXPLORER or NETSCAPE NAVIGATOR. However, the use of an Internet browser is only a single method of implementing the present invention. Additionally, some and/or all aspects of the present invention could manifest themselves using non-browser-based Internet technology (e.g., ICQ, Instant Messaging technology, wireless devices, personal digital assistants (“PDAs”), kiosks, set-top boxes, etc.), or through original interface technology that may be developed in the future.

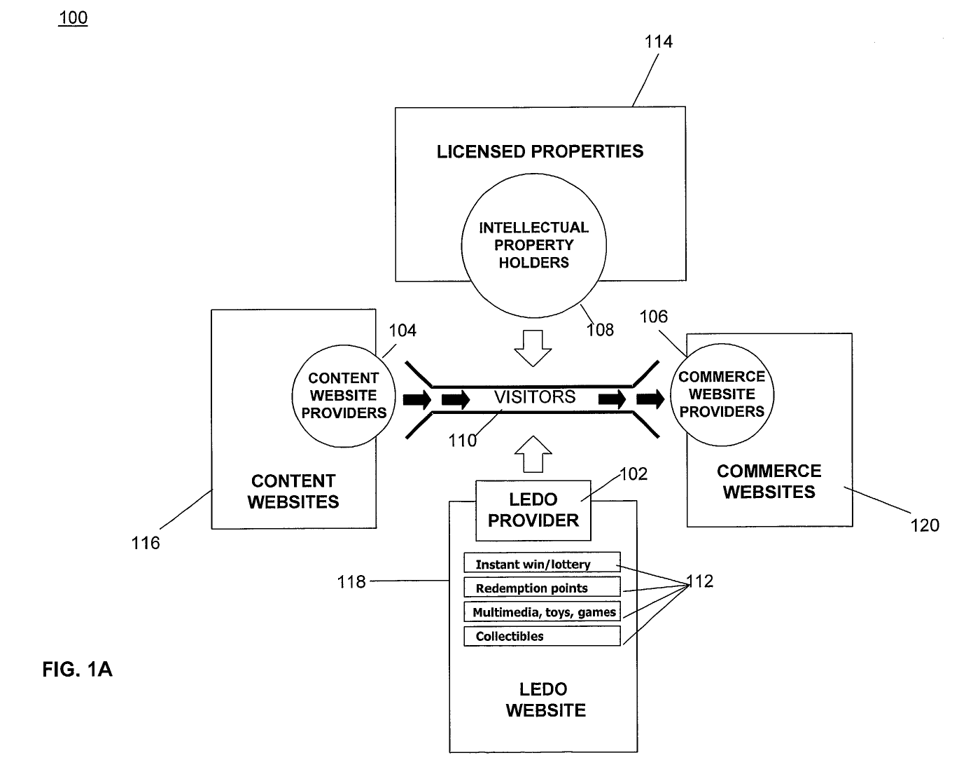

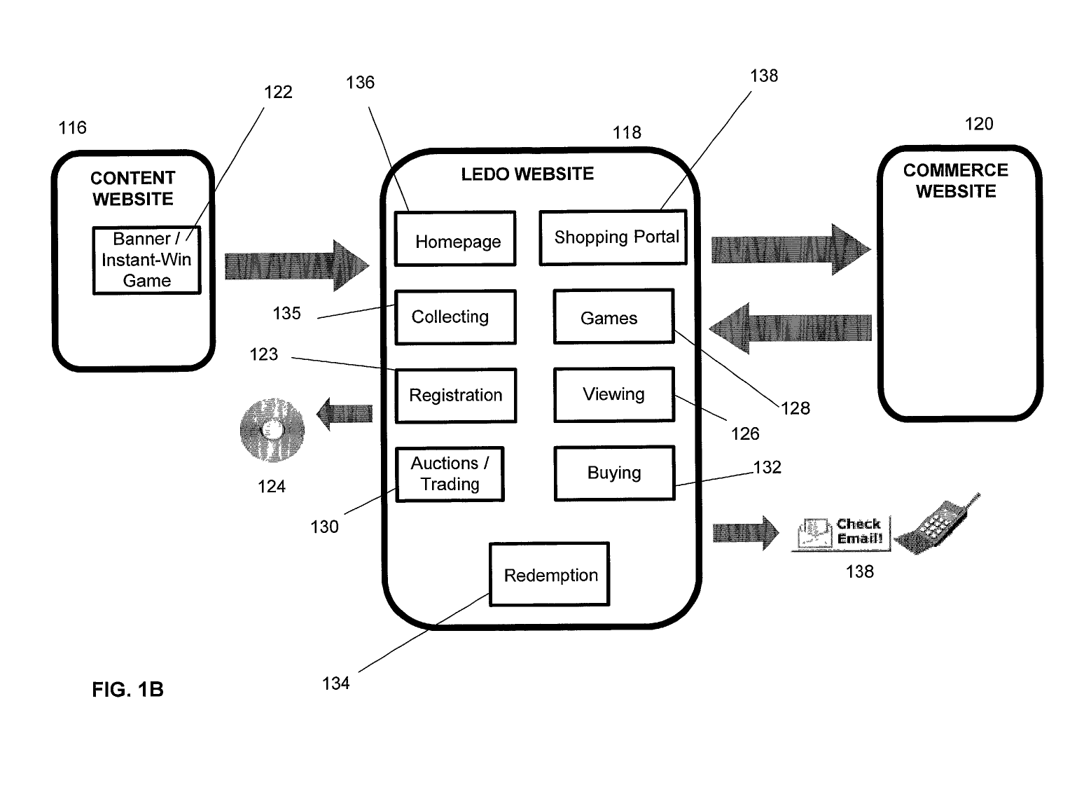

Referring now to the drawings, in which like numerals represent like elements throughout the several figures, aspects of the present invention and the preferred operating environment will be described. FIG. 1A illustrates the basic structure of the system and business method utilized in an exemplary embodiment of the present invention. In this embodiment, the system 100 comprises a LEDO provider 102, a content website provider 104, a commerce website provider 106, an intellectual property holder 108 and on-line users 110. The LEDO provider 102 contributes LEDO technology to the system 100 that comprises the characteristics 112 of instant-win, lottery functionality, redemption points functionality, multi-media/toy/gaming functionality, and collectibility. The LEDOs created by the LEDO provider 102 may be based upon the licensed properties 114 of the intellectual property holder, such as famous trademarks/tradenames, characters, actors, musicians, athletes, etc. The content web site provider 104 operates content websites 116 to which on-line users 110 will be attracted based on their personal interest in the content of the participating content web sites 116. The on-line users 110 will then receive and/or be awarded no-cost LEDOs through the content websites 116. After experiencing the LEDO concept, the on-line users 110 will be directed to websites 118 that are operated by the LEDO provider 102 and/or commerce website providers 106. The on-line users 110 may then experience the interactive features of LEDOs and/or receive/buy more LEDOs directly from the LEDO provider 102 and/or through the purchase of goods and services from commerce websites 120 operated by the commerce website provider 106.

FIG. 1B illustrates the structure and flow of the on-line user experience utilizing an exemplary embodiment of the present invention. While the exemplary embodiment described below comprises multiple websites comprising multiple webpages, those skilled in the art will recognize that the present invention may be implemented using various configurations of on-line locations, including single and/or multiple websites, which may further comprise single and/or multiple webpages. In this embodiment, an on-line user 110 will visit a content website 116 based upon their personal interest in the subject matter thereof. Upon visiting the site 116, the on-line user 110 will be presented with a banner/text/image 122 offering the user 110 the opportunity to learn about/earn/win LEDOs. Upon “clicking” the banner/text/image 122, the user 110 is offered an opportunity to learn about/earn/win LEDOs through the registration section of a LEDO provider website 118. Upon earning/winning LEDOs, the user 110 is solicited and/or required to register 123 with the LEDO provider website 118. In addition to the initial registration process 123, this method allows a LEDO provider 102 to increase user participation in the future through the use of such methods as targeted e-mail and wireless messages 138.

Once the user 110 has completed the registration process 123, the user 110 is given immediate on-line access to a basic or “stripped-down” copy of the user's LEDOs. This allows for instant gratification during the registration process. Then, a compact disc (“CD”) 124 is then delivered to the user 110 offline that contains an encrypted library of the chosen content line, as well as a viewing program, such as an “album”, for the user's LEDOs. The LEDOs contained on the CD 124 are fully-functional and may contain a number of interactive features. As users 110 receives LEDOs through the system and method of the present invention, they are given the proper passwords/codes to unencrypt the various LEDOs on the CD 124 as they are awarded. This embodiment allows for immediate access to all new LEDOs upon receipt of the LEDOs through codes/passwords and overcomes bandwidth limitations of users that utilize slow connection to the Internet. However, those skilled in the art will recognize that LEDOs could be delivered to users in many different, well known methods, both on-line and offline depending upon the type of networks resources available to the LEDO provider and/or particular users. Such method may comprise providing LEDOs as a browser plug-in, in streaming format, etc.

After registering with the LEDO provider 102, a user 110 may engage in a number of LEDO activities on the LEDO provider website 118. In this embodiment, these activities comprise viewing/interacting with their LEDO collections 126, playing LEDO-based games 128, auctioning/trading LEDOs with other users 130, buying LEDOs 132, redeeming LEDOs with the LEDO provider 102 for goods and services 134, collecting additional LEDOs 135, and/or receiving new information about the use of LEDOs and LEDO programs in areas such as the LEDO provider website homepage 136.

In addition, users 110 may earn additional LEDOs by purchasing goods and services from the LEDO provider's merchant partners. In this embodiment, a user 110 would be directed to these merchant partners commerce-based websites 120 through a shopping portal 138 contained within the LEDO provider website 118. This portal 138 will transport the user 110 to a commerce website 120 affiliated with the LEDO provider 118. If the user 110 then purchases goods and/or services from the commerce website 120, the user 110 is then notified of the award of new LEDOs and may return to the LEDO provider website 118 to obtain access to the new LEDOs.

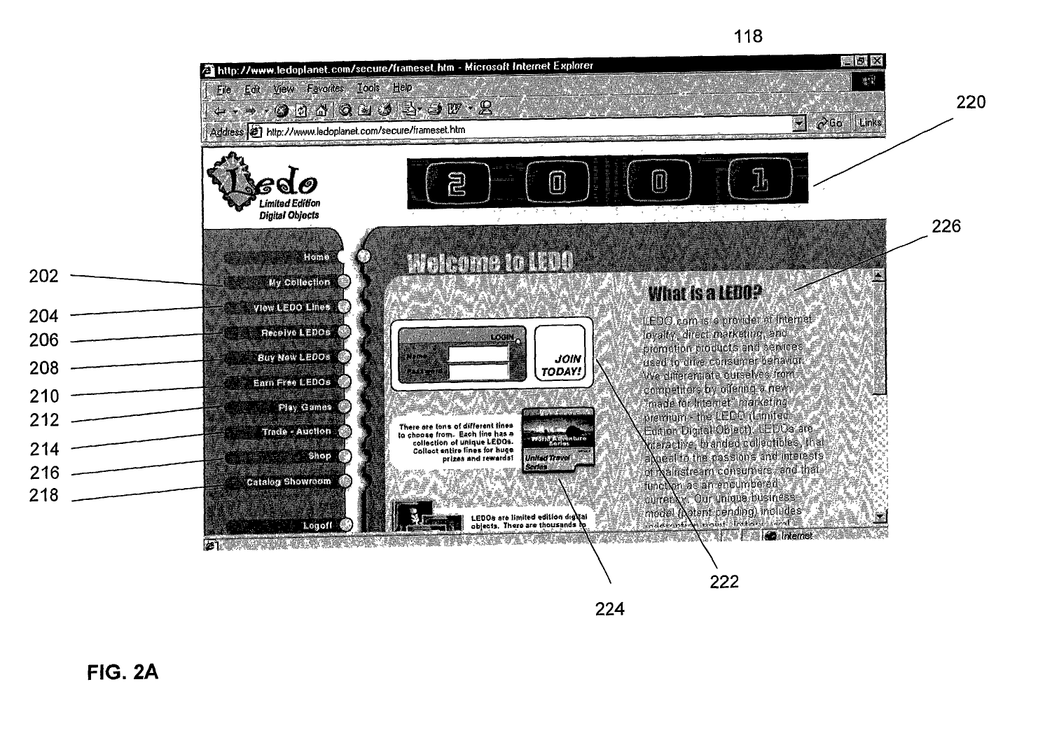

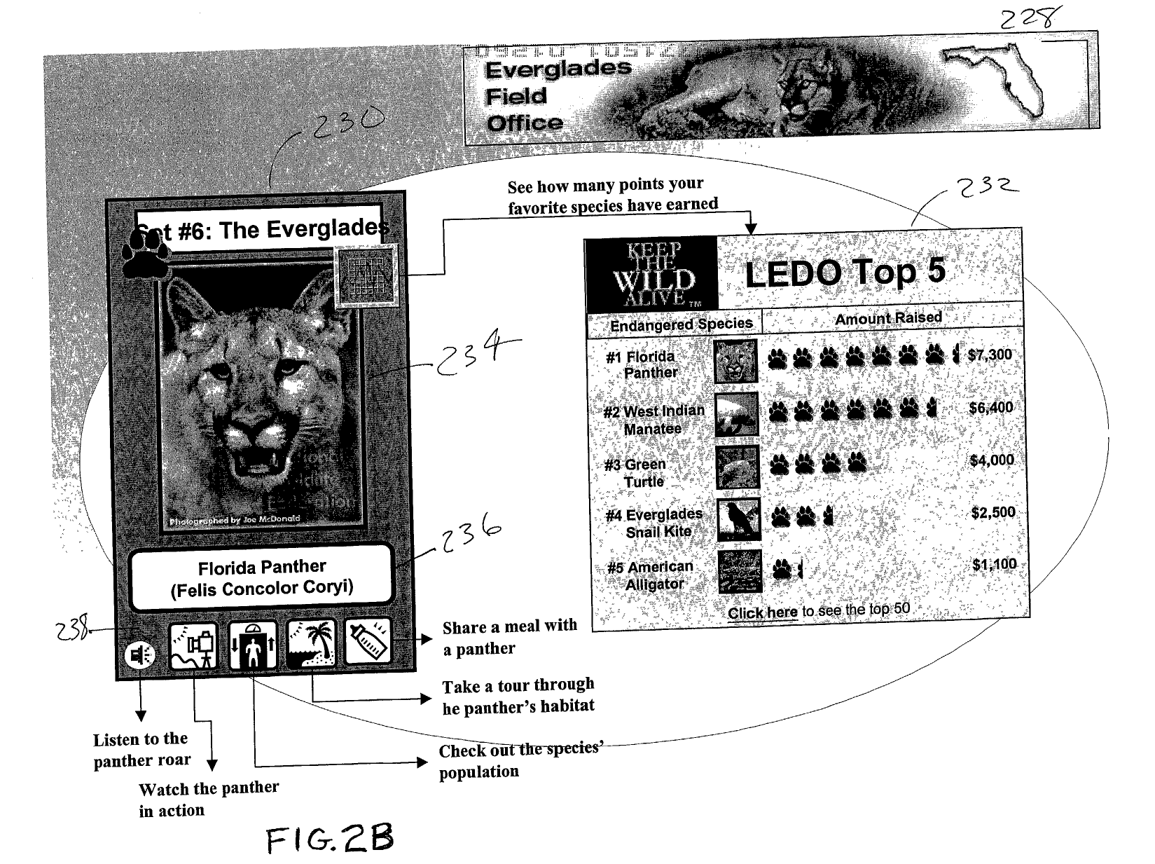

FIG. 2A is a screen shot of an exemplary LEDO provider website 118. In this embodiment, the LEDO provider website 118 contains on-screen buttons that are utilized for viewing a user's LEDO collection 202, viewing other available content lines of LEDOs 204, receiving access to new LEDOs 206, buying new LEDOs 208, earning free LEDOs 210, playing on-line games with LEDOs 212, trading/auctioning LEDOs 214, shopping for goods/services that provide LEDO rewards 216, and redeeming LEDOs for goods and/or services from the LEDO provider's on-line catalog showroom 218. In addition, the LEDO provider website may provide banner/text/image links 220 to on-line games and/or instant win opportunities for receiving more LEDOs. In addition, this exemplary screen shot illustrates a login dialog box 222 for new and/or returning LEDO users, an image representing the existence of a specific content line of LEDOs relating to the subject of travel 224, and introductory information relating to LEDO technology 226.

FIG. 2B is an exemplary screen shot of a webpage 228 an exemplary embodiment of a LEDO 230 to be utilized with an exemplary embodiment of the present invention. This webpage 228 contains an image of a LEDO 230 directed to the specific subject of the Everglades an image 232 displaying information pertaining to the specific content line of LEDOs to which the displayed LEDO 230 belongs. The exemplary LEDO 230 comprises an image 234 of a Florida Panther, species information 236 and a series of on-screen buttons 238 for interacting with the LEDO 230.

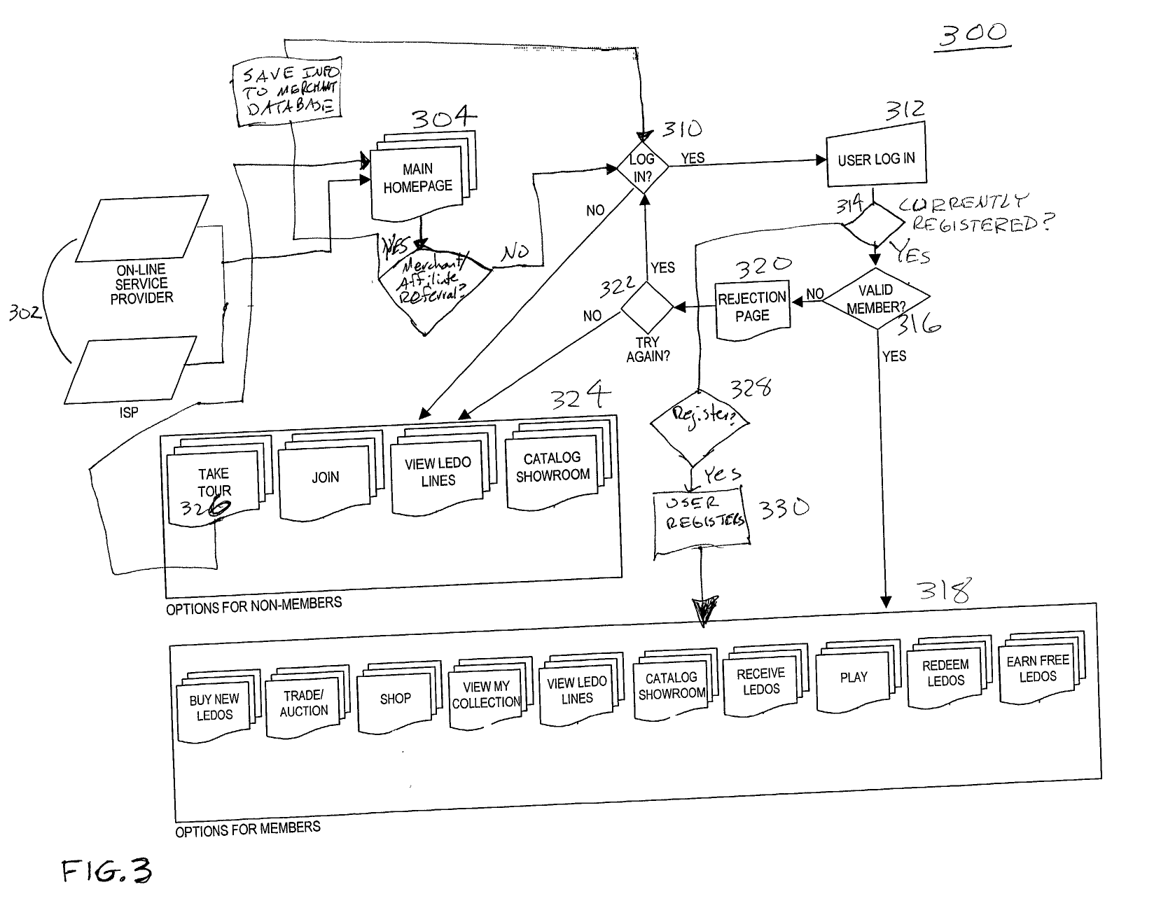

FIG. 3 is a logic flow diagram illustrating a user access process 300 of an exemplary embodiment of the present invention. In step 302, a user may obtain Internet access through an on-line service provider or an Internet service provider (“ISP”). Those skilled in the art will recognize that such access can be gained through a variety of means, including networks based on cellular phones, cable systems and wireless devices. In step 304, a users will access the LEDO provider's main homepage. In step 306, the LEDO provider webpage conducts a query to determine whether the user has connected to the LEDO provider webpage by way of a partner merchant website or an affiliate website that actively recruit members for the LEDO provider. If so, in step 308, this data will be stored in the LEDO provider's member database.

Next, in step 310, the user is queried as to whether they wish to “log in” to the LEDO provider website. If so, in step 312, the user may “log in” to the LEDO provider website. In step 314, if the user is currently registered, they will enter their user name and password. In step 316, a security check is performed to determine if the user is a valid user by comparing their inputs to information in the member database. If the system determines they are a valid user, in step 318, the user will be able to proceed to make fill use of the website with fill access to all options for registered users. If not, in step 320, the user is sent to a rejection page. In step 322, the user is queried whether to try the log in process again. If so, the user is returned to step 310. If not, or if in step 310 the user does not wish to log in, they will have limited access to the website, in step 324, limited to the options for non-members. Included in these options, in step 326, the user may “tour” the LEDO provider website. After concluding the tour, the user will be returned to the LEDO provider website's main homepage. In step 328, if the user is not a registered user, they are queried as to whether they wish to register with the LEDO provider website. If so, in step 330, the user will register with the LEDO provider website and will proceed to step 318 where they will be given full access to all options for registered members. If not, the user is returned to step 310.

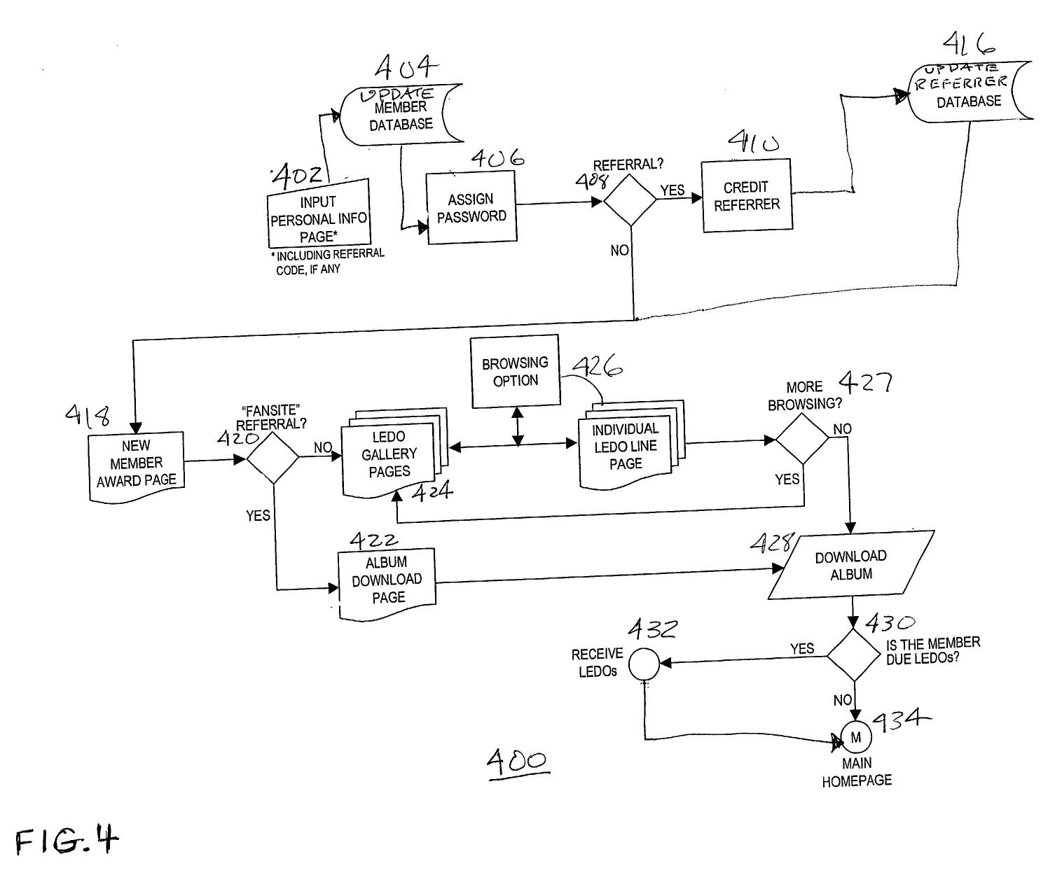

FIG. 4 is a logic flow diagram illustrating a user enrollment process 400 of an exemplary embodiment of the present invention. In step 402, from the a registration webpage within the LEDO provider website, a new user will be asked to input personal info, which may comprise the user's name, address, e-mail address, telephone number, desired user name, and a referral code, if they have one. A new user would have a referral code if another registered member recruited them to register. In step 404, inputted personal info will be posted to the LEDO provider's user database. In step 406, the user database will ensure the new user's desired user name is not already taken and will assign the new member a password.

In addition, a new user may have a associated referrer, either because the user inputted a referral code, or because they were “tagged” with one by the website from which they transferred to the LEDO provider website. In step 408, a query is conducted to determine whether the user has an associated referrer. If so, in step 410, the referrer will receive credit for recruiting the new user. Depending on the referral program in place between the LEDO provider and the referrer, the referrer may receive such items as monetary revenue and/or LEDOs for recruiting the new user. In step 416, the referrer will be listed in the LEDO provider's user database as the new user's referrer of record. This will allow the referrer to continue to earn additional monetary revenue, LEDOs, etc., as the new user earns LEDOs through the system and method of the present invention.

In step 418, the new user will be thanked for joining and reminded/informed of the number and/or value of the LEDOs they have been awarded for registering, as well as other pertinent information. In step 420, a query will be conducted to determine whether the new user came to the LEDO provider website through a referral from a “fansite”, which is associated with a specific content line. If so, in step 422, the viewing album that the user will receive and/or download will be pre-specified, as part of the “tagged” information that accompanied the new user to the LEDO provider website. If the user is not associated with a fansite referral, in step 424, the new user will be transported to a LEDO gallery webpage, where they will be able to use conventional searching options/tools (directory, keyword, etc.) to browse through and review individual LEDO content lines. In step 426, the new user will be allowed to select a particular LEDO content line to start collecting if they have not already done so. In step 427, the user will be queried if they wish to continue browsing. If so, the user is returned to step 424. If not, the user proceeds to step 428.

In step 428, the system will deliver the new user's selected or pre-selected viewing album to them, through such methods as a digital download, an offline CD, etc. The viewing album may comprise a file or series of files that either as a browser plug-in or as a stand-alone software application, would include an on-screen collector's album for a given content line of LEDOs. This will provide the user with the ability to view, sort, play with, and/or organize their LEDO collection. In addition, this will provide the audio/video content normally associated with any given content line of LEDOs, comprising such items as sound files (.wav, mp3, etc.), images (.gif, jpg, etc.), and movie/media clips (.mov, avi, etc.). These files may be protected with passwords, cryptography, and other such means to disallow users from accessing the individual LEDOs unless they are legal, authenticated owners of the LEDOs. In step 430, a query is conducted to determine whether the user is due additional LEDOs. If so, in step 432, the user will be transported to a page within the LEDO provider website where they can receive the appropriate information to access their new LEDOs. If not, or after receiving the new LEDOs, in step 434, the new user will be returned to the main homepage of the LEDO provider website.

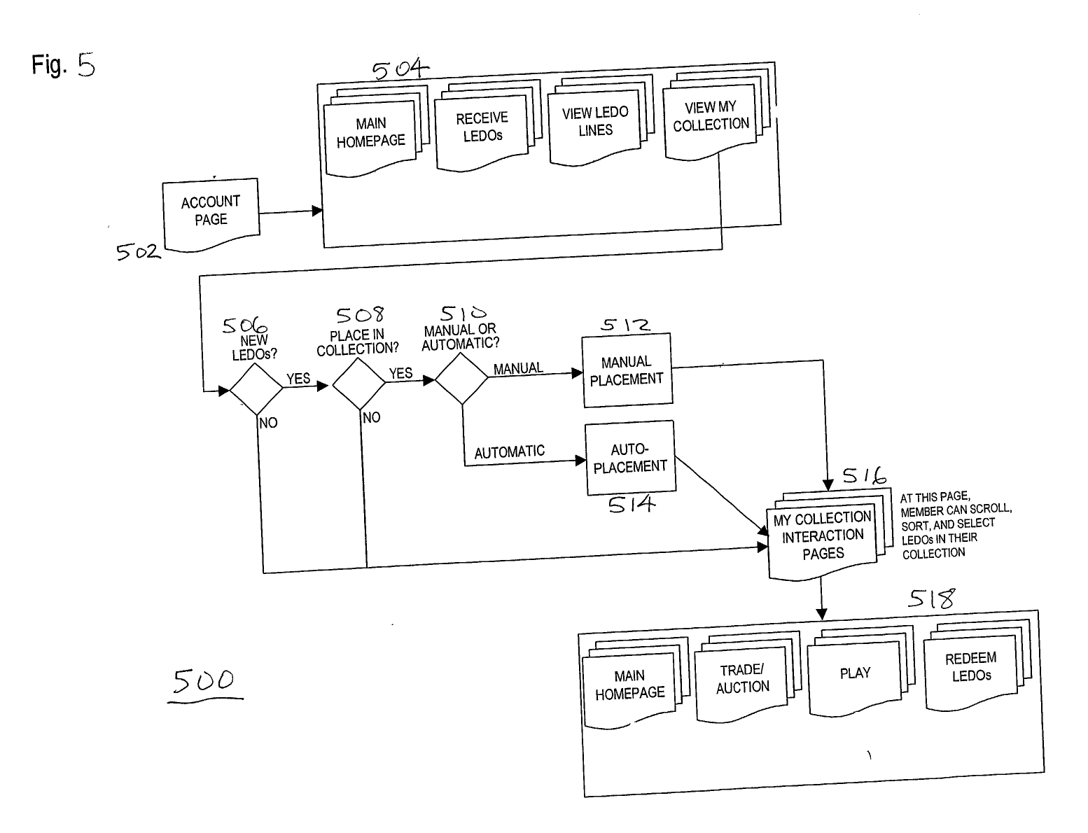

FIG. 5 is a logic flow diagram illustrating a process 500 for viewing a user's LEDO collection within an exemplary embodiment of the present invention. In step 502, a registered user, upon logging into the LEDO provider website, will be transported to a personal account page. While on their account page, a user may view information relevant to their collection of LEDOs, including a count of how many LEDOs they have, broken down by LEDO lines; how many LEDOs, if any, they have earned but not received; information regarding any trades/auctions of their LEDOs in process or pending; and also how many new LEDOs they have received, either directly from the LEDO provider, through another user (through trades/auctions), if any. From this page, in step 504, the user will be able to perform various functions, comprising returning to the LEDO provider website's main homepage, receiving LEDOs (if the user has any due), viewing LEDO lines, or viewing the user's LEDO collection. If the user chooses to view their LEDO collection, in step 506, the user will be queried as to whether they have any new LEDOs to place in their collection. If so, in step 508, the user is queried as to whether they would like to place the new LEDOs into their collection. In step 510, the user is queried whether to manually or automatically place their LEDOs into their collection. If manual placement is chosen, in step 512, the user uses a mouse or similar interactive device to click and drag their LEDOs into the appropriate locations within the appropriate collector's album. If automatic placement is chosen, in step 514, the LEDO provider website uses prior art sorting systems to automatically sort the user's LEDOs for them.

Thereafter, in step 516, the users are transported to a webpage within the LEDO provider's website on which the user will be able to scroll, sort, organize, and select LEDOs from their various collector's albums with which to interact. It is further anticipated that advertising/marketing materials may be embedded in this area of the LEDO provider website. Once a user is through viewing their LEDO collection(s), in step 518, they will be allowed to proceed back to the main homepage or to other sections of the LEDO provider website.

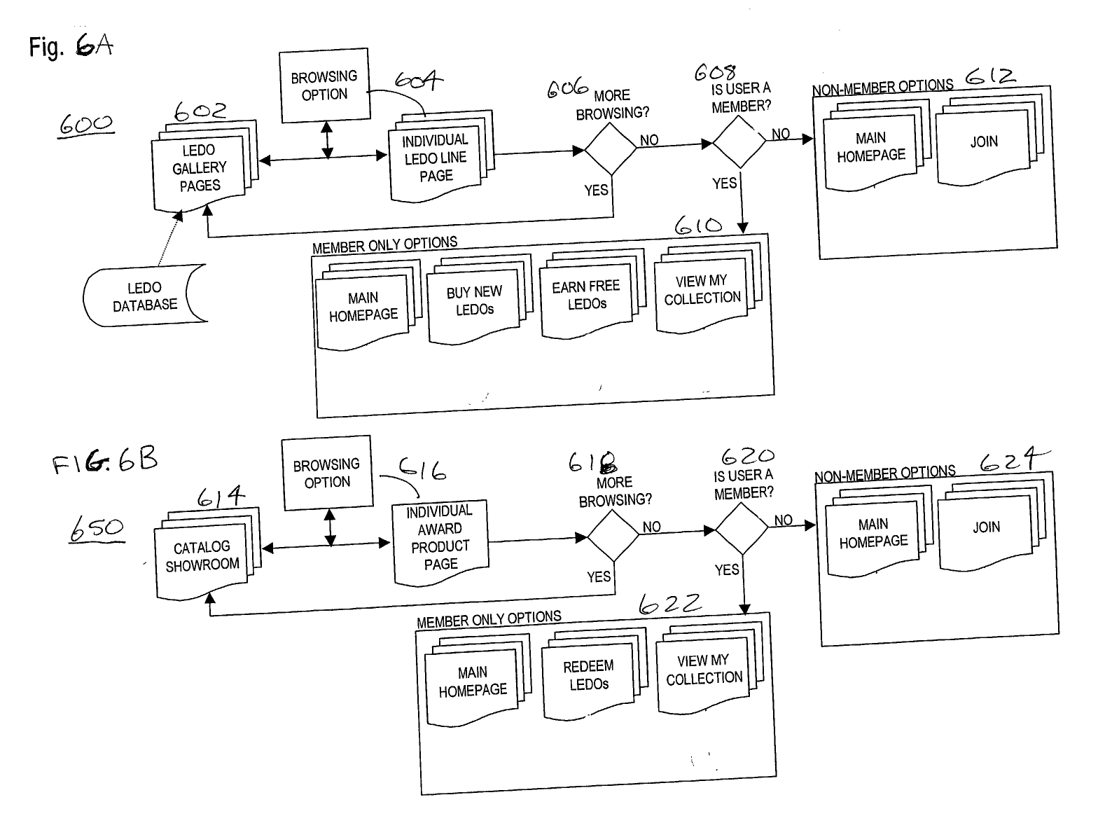

FIG. 6A is a logic flow diagram illustrating a process 600 for displaying LEDO content lines to users of an exemplary embodiment of the present invention. In step 602, a user is transported to gallery webpages within the LEDO provider website, where they can explore different content lines of LEDOs available on the LEDO provider website. In step 604, the user may utilize conventional browsing options, such as directories, key word searches, etc., to view information pertaining to an individual LEDO content line. This information may comprise: a description of the characters/theme of the content line; statistics regarding the number of LEDOs in the content line; rarity of the content line; denominations of the LEDOs available within the content line; current popularity of the content line with other collectors; the monetary value for top LEDOs within the content line in secondary markets; a description of the interactivity/features offered by LEDOs in the line, comprising such features as images, sounds, movie clips, instant-win games, other games (e.g. fantasy sports, online racing, etc.), screensavers, recipes, etc.; links and/or information to fansites and/or related content sites; links to sections with the LEDO provider website's catalog showroom of redemption prizes associated with the content line; sample images/sounds, etc., of some of the LEDOs and/or the collector's album for the particular content line.

In step 606, upon concluding a review of a particular content line, the user will be queried as to whether they wish to continue browsing content lines. If so, the user is returned to step 602. If not, in step 608, the user is queried as to whether they are a registered user. If so, in step 610, the user may fully access all options within the LEDO provider website for registered users. If not, in step 612, unregistered users will have the option to either return to the main homepage of the LEDO provider website or to participate in the enrollment process reflected in FIG. 4 as described above.

FIG. 6B is a logic flow diagram illustrating a process 650 for displaying redemption opportunities to users of an exemplary embodiment of the present invention. In that regard, viewing redemption opportunities is similar to viewing LEDO content lines. The chief difference is that a user will be viewing products, services, and other awards/prizes available for redemption. In step 614, a user is transported to a catalog showroom webpage within the LEDO provider website. In step 616, the user will be allowed to browse to an individual award product page, that show with pictures, text, and/or sounds/movies redemption merchandise. As part of the browsing experience, it is anticipated that a user will be able to see redemption merchandise in groups, grouped according to themes (often corresponding to individual LEDO content lines), or according to product/service categories. The presentation/layout of individual groupings will add to the overall excitement experienced by the user by displaying exciting, unique redemption merchandise grouped together around themes that appeal to the personal interests of users. After browsing an individual award product page, in step 618, the user is queried as to whether they wish to continue browsing. If so, the user will be returned to step 614. If not, in step 620, a query will determine whether the user is a registered member. If so, in step 622, the user may fully access all options within the LEDO provider website for registered users. If not, in step 624, unregistered users will have the option to either return to the main homepage of the LEDO provider website or to participate in the enrollment process reflected in FIG. 4 as described above.

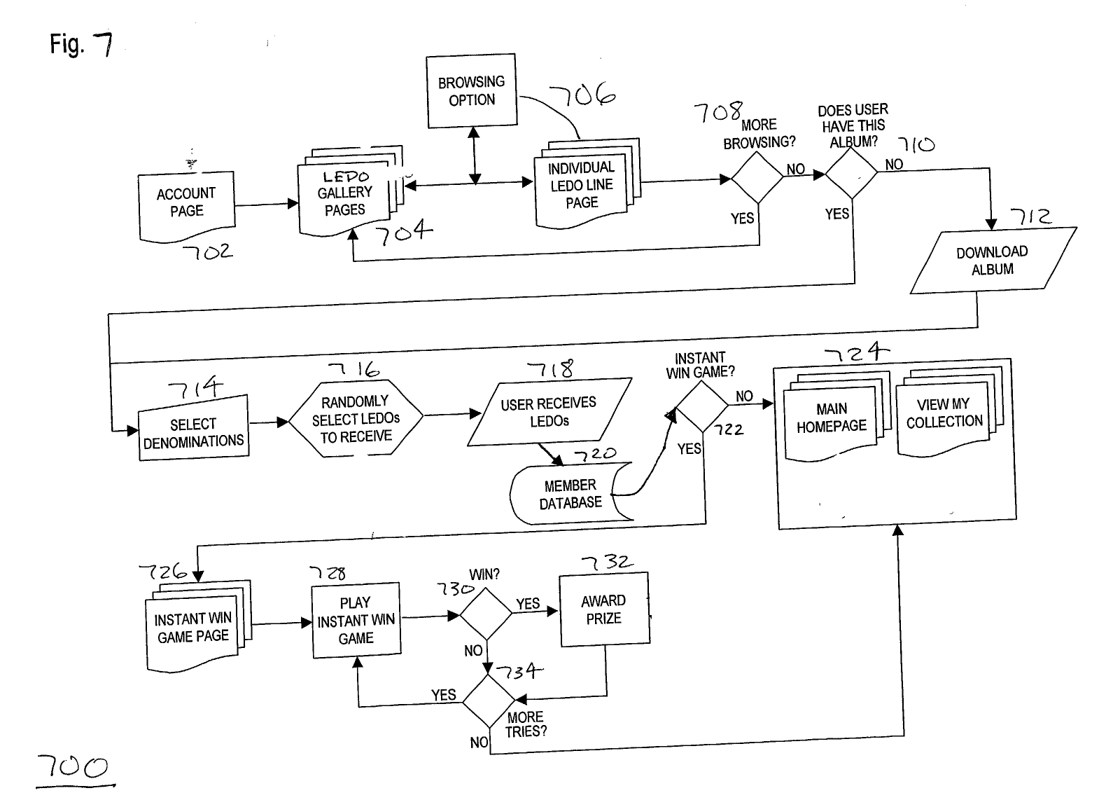

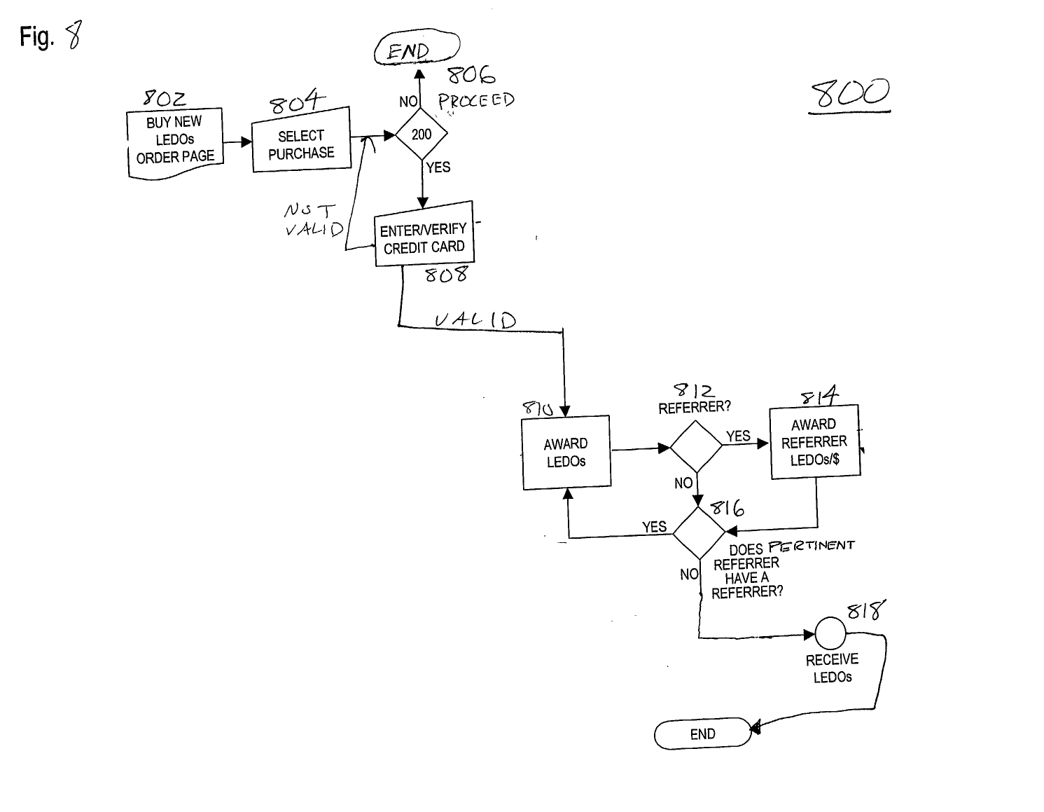

FIG. 7 is a logic flow diagram illustrating a process 700 for awarding LEDOs to users of an exemplary embodiment of the present invention. In step 702, a user is transported to a personal account page. On that page, the user will be able to get information regarding their member account, comprising: the quantity of LEDOs in their collection, both in total and broken out by content line; the number of LEDOs they are due but have not received; the number of new LEDOs they have received but not placed in their album; the number of trade offers and/or auction bids they need to respond to, if any; the number of trades/auction transactions involving them that have been completed since the last time they reviewed their account information; etc.

In step 704, the user will be allowed to browse through LEDO gallery pages, navigating directories and doing searches to review the different individual LEDO content lines. In step 706, the user may select an individual LEDO content line for later acquisition. In step 708, the user is queried as to whether they wish to continue browsing LEDO gallery pages. If so, the user is returned to step 704. If not, in step 710, a query is conducted to determine whether the user has obtained the viewing album for the selected LEDO content line(s). If not, in step 712, the LEDO viewing album is either downloaded to the user, delivered to the user on an offline CD, and/or through another online or offline method. If so, or once the viewing album is delivered to the user, in step 714, the user may be required to select the denominations of the LEDOs he will be receiving if a choice of denominations exists.

A variety of denomination schemes are possible, but some exemplary denominations include 1, 10, and 100, the increasing denominations requiring larger monetary expenditures through online purchases and/or direct purchase of LEDOs. For purposes of optimizing the collecting experience, different denominations may exist for each LEDO. This will allow members who buy large quantities of goods/services online from partner merchants to collect the 10 or 100 denomination LEDOs, while other members who spend a lower amounts may still collect the 1 denomination LEDOs and have the same quality of collecting experience as completing a set or line is the goal of many collectibles, including LEDOs. In order to incent users to spend larger amounts with partner merchants, additional LEDO features may be built into higher denomination LEDOs to encourage user interest in the higher denominations LEDOs. However, users will also be able to have a compelling and satisfying collecting experience through completing collections of lower denomination LEDOs.

In step 716, a random determination will be made as to which LEDOs the user will receive from the specific LEDO content line they previously selected. Different LEDOs from within a given LEDO content line will have different levels of rarity, translating into differing percentage likelihoods of being awarded as LEDOs are randomly selected for receipt by users. In step 718, the user receives LEDOs. While the actual mechanism for this receipt may vary, in step 720, this exemplary embodiment comprises data being posted to the LEDO provider website's member database whereby the physical file(s) associated with each LEDO will already exist on the user's hard drive/storage device. Thus, in steps 718 and 720, the act of “receiving” LEDOs will comprise the granting of permission to interact with LEDOs already on the user's system, not the actual download of the LEDO file(s) at the time of award.

It is anticipated that the award of LEDOs will be a dramatic, entertaining experience, including graphics and sound, providing the user with instant gratification. An additional part of this instant gratification will derive from the anticipation of finding out which specific LEDOs within a content line are being awarded. Further, some content lines of LEDOs may comprise an instant-win game. Thus, in step 722, a query will determine whether a specific LEDO that is awarded to a user comprises an instant-win game. If not, in step 724, the user may continue viewing their LEDO collection and/or participate in other aspects of the LEDO provider website. If so, in step 726, the user will be presented with a LEDO comprising an instant-win game.

In step 728, the user will play an instant win game on the screen of their computer/system and/or other device, with each LEDO comprising a “chance” to “win” an award/prize. In addition, a user may win an instant prize from playing the instant-win game comprised by an individual LEDO, or they may win because they have completed collecting a set or grouping of LEDOs. It is anticipated that there may be variety of compelling instant-win/sweepstakes/lottery-type games, which will vary from content line to content line of LEDOs. A LEDO provider webpage database or other external databases may contain the prizing structure, rules, and prize definitions. Thus, in step 730, a query is conducted as to whether the user has won a prize. If so, in step 732, the user is awarded a prize(s) and this information will be posted to the LEDO provider website's member database, and as appropriate, become fulfillment orders to delivered to the user. If not, in step 734, a query is conducted to determine whether the user has any unused chances in the instant-win game. If not, the user is returned to step 724. If so, the user is returned to step 728. When the user has no MORE TRIES, or if there is no INSTANT WIN GAME associated with the line of LEDOs that were just awarded, the user will be done with this process, and will be given the choice to either return to the MAIN HOMEPAGE or to VIEW MY COLLECTION.

It should be noted that as disclosed within this application, LEDOs can be “awarded” or “received.” A LEDO that has been earned, but to which the user does not yet have access, is said to have been awarded. For example, a user could purchase merchandise from a partner merchant website and could earn 5 LEDOs for doing so. These 5 LEDOs would need to be awarded, i.e., posting the number of LEDOs earned to the user's account. Then the 5 LEDOs would need to be received, i.e., the user chooses what content line of LEDOs they wish to obtain access to, in what denominations they will be issued, and actually gains access to them).

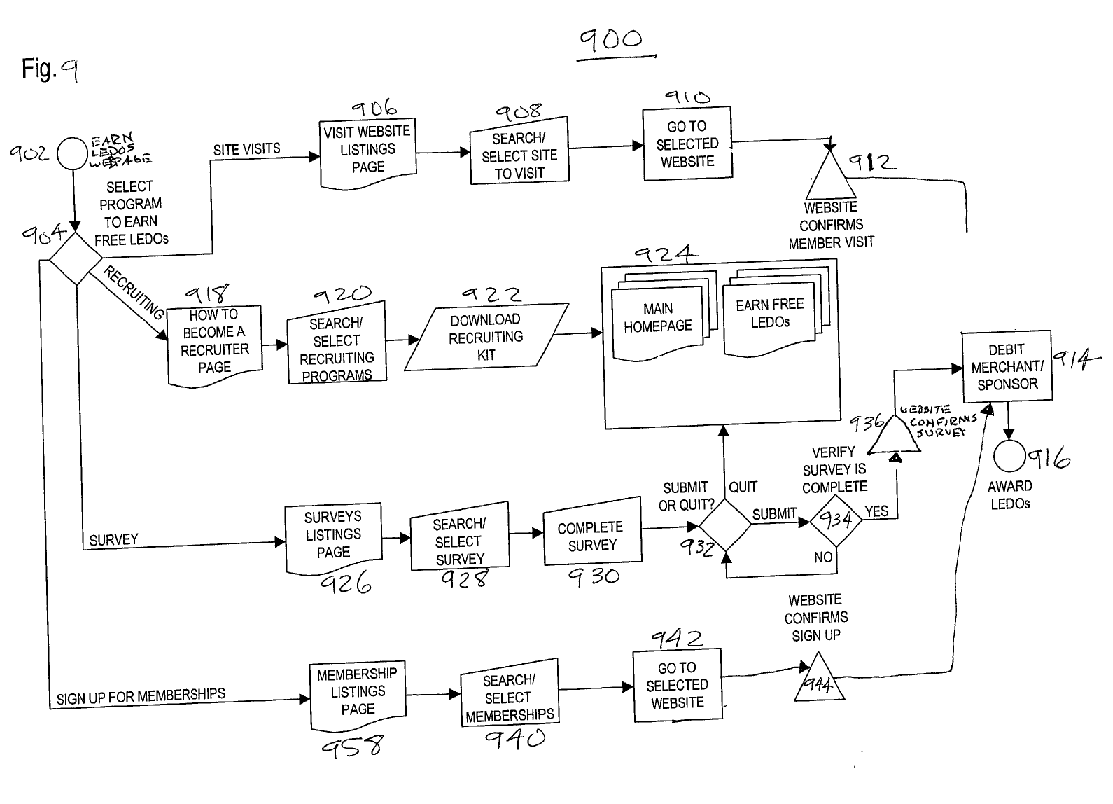

FIG. 8 is a logic flow diagram illustrating a process 800 for purchasing of LEDOs by users and awarding such LEDOs to users of an exemplary embodiment of the present invention. In step 802, a user is transported to a webpage within the LEDO provider website designed to enable the purchase of LEDOs. In step 804, a user can select to purchase whatever quantity of LEDOs they wish to buy directly from the LEDO provider. Except where not allowed by law, i.e., for states/countries with specific instant-win/sweepstakes/lottery laws to the contrary, LEDOs bought by users directly from the LEDO provider will be no different than LEDOs earned through other means. Where legal requirements dictate, the LEDOs that users my receive will not utilize instant-win/sweepstakes/lottery features. In step 806, the user will be queried as to whether they wish to proceed with their purchase. If so, in step 808, a query will verify/accept the means of payment presented by the user, such as a credit/debit card. If the payment means is not verified/accepted, the user will be returned to step 806. If the payment means is verified/accepted, the user will proceed to receive an award of LEDOs as described below.

In step 810, the user is transported to a webpage with the LEDO provider website designed to enable the award of LEDOs to users. In step 812, a query is conducted to determine whether the user is connected with a referrer that is entitled to a monetary award and/or an award of LEDOs. If so, in step 814, the referrer is awarded LEDOs and/or a monetary award. In that regard, a key aspect of this exemplary embodiment is the unique marketing approach whereby websites operators, companies, and other users will be incented to recruit new users by rewarding them with additional LEDOs or monetary awards whenever their recruits are awarded LEDOs. This aspect of the present invention will allow the development of a classic pyramid marketing scenario, where for example person A can recruit person B as a LEDO user, who in turn can recruit person C as a LEDO user. When person C is awarded LEDOs, all three users would receive LEDOs, and potentially persons A and B could receive monetary awards, in accordance to the structure of the applicable recruiting/affiliate program as defined in the LEDO provider websites member database. Thus, in step 816, a query is conducted to determine whether the pertinent referrer is associated with another referrer. If so, the process returns to step 814 and rewards the additional referrer. If not and/or once the point is reached where the pertinent referrer is not associated with another referrer, in step 818, the user will proceed to receive LEDOs as described in FIG. 7 above.

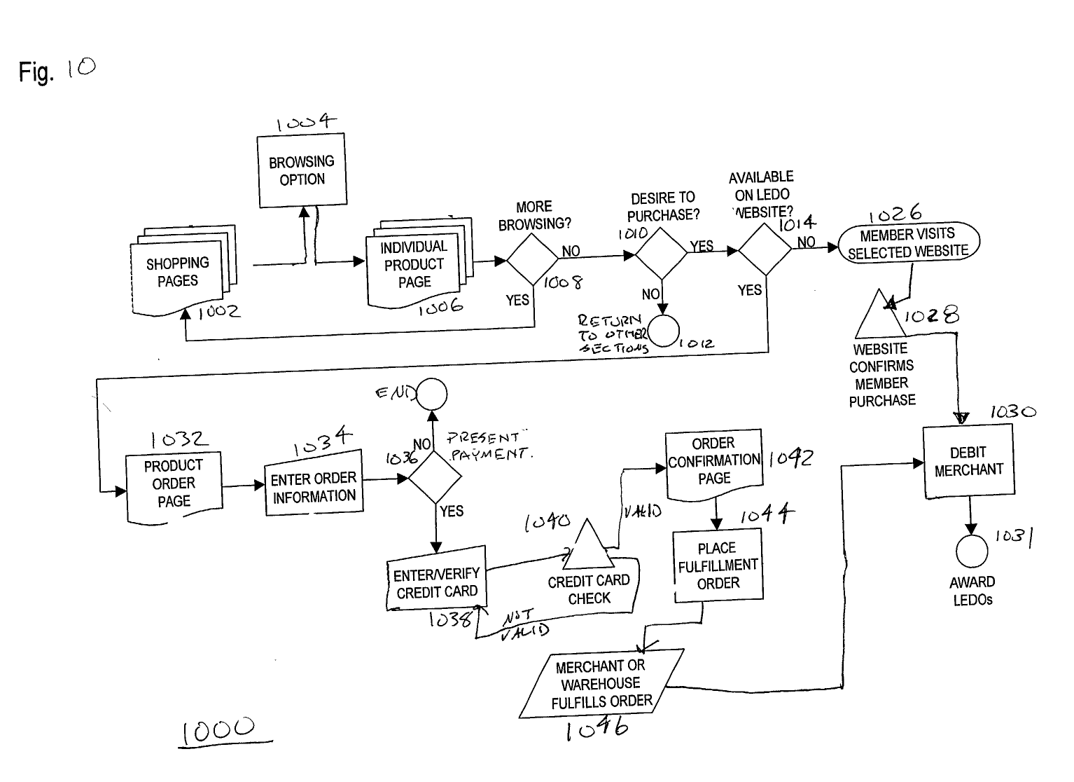

FIG. 9 is a logic flow diagram illustrating a process 900 for allowing a user to earn no-cost LEDOs through an exemplary embodiment of the present invention. In step 902, a user is transported to a webpage located within the LEDO provider website that contains information/access to allow the user to select a program to earn free LEDOs. It is anticipated that at least four methods for earning free LEDOs may be used with the present invention, comprising site visits, recruiting, taking surveys, and signing up for memberships. Thus, in step 904, the user is queried to select one of these four methods for earning free LEDOs.

In step 906, the user is transported to a webpage with the LEDO provider website that will allow the user to select websites to visit to earn free LEDOs. On this webpage, the user will see information such as a short description of the sites they may visit, the number of LEDOs they can earn for performing the visit, and a URL link, or hyperlink, to click to transport them to the selected website. Thus, in step 908, the user selects a website to visit. In step 910, the user is transported to the selected website. In step 912, the selected website detects the user's visit and reports/confirms the user's visit to the LEDO provider website. This report/confirmation will inform the LEDO provider website as to which user completed a visit and how many LEDOs should be awarded to the member. In step 914, when the report/confirmation is received by the LEDO provider website, the merchant/sponsor of the particular website is debited for the appropriate amount of LEDOs and this debit is recorded in the merchant/sponsor database. In step 916, the LEDO provider website proceeds to award LEDOs to the user. It should be noted that in the exemplary embodiment of this invention, it is desirable to have the capability of having websites/merchants/sponsors participate in the LEDO program without “up-front” costs, and without having to acquire/hold inventory. Thus, in the process just described, the site visit sponsor would not have a “debt” to our company until member visits/purchases are completed.

In step 918, if the user chooses to recruit other users, they will be transported to a webpage within the LEDO providers website to receive information on how associated pyramid/affiliate recruiting programs operate. In step 920, they will be able to search and select a recruiting program in which they wish to participate. Once the user has selected a recruiting program, in step 922, a recruiting kit will be downloaded to the user, if one is available and appropriate, either as an electronic download, delivered offline on a CD and/or by other online or offline means. It is anticipated that such recruiting kits will comprise materials designed to help recruiters sign up new LEDO users, and will often include HTML script and graphic/sound images to add to recruiter's webpages. In addition, the recruiting programs will include programs directed to specific content lines of LEDOs. In step 924, after the recruiting kit is downloaded to the user, the user may proceed to other sections of the LEDO provider website, including the main homepage or the page directed to earning free LEDOs.

In step 926, if the user chooses to take surveys, they will be transported to a surveys listing page. In step 928, the users will be able to search/select which survey they wish to take. It is anticipated that on this page, the user will see information comprising a short description of each survey they can take, the number of LEDOs they can earn for performing the survey, the approximate amount of time required to take the survey, and the ability to select which survey they wish to take. In step 930, the user takes a selected survey. In step 932, a query is made as to whether the user has submitted the survey results. If so, in step 934, a query is conducted as to whether the survey results are complete. If so, in step 936, a report of the completion of survey is delivered to the LEDO provider website, the user will be awarded LEDOs. In step 914, the LEDO provider website will debit the survey operator's merchant/sponsor account.

In step 938, if the user decides to sign up for a membership, the user is transported to a membership listing page. It should be noted that the key aspect of this method of earning free LEDOs is that instead of giving users LEDOs for visiting websites, they are given to users for signing up for various membership and/or subscriptions. This may be done at a merchant/sponsor's website, or it can be done on the LEDO provider website, with the appropriate information being transmitted to the merchant/sponsors. Thus, in step 940, the user may search/select a membership to accept. In step 942, the user is transported to the appropriate website and/or webpage to complete the process of signing up for the selected membership and/or subscription. In step 944, a report is delivered to the LEDO provider webpage confirming acceptance of the membership/subscription and the user is award LEDOs. In step 914, the LEDO provider website will debit the survey operator's merchant/sponsor account.

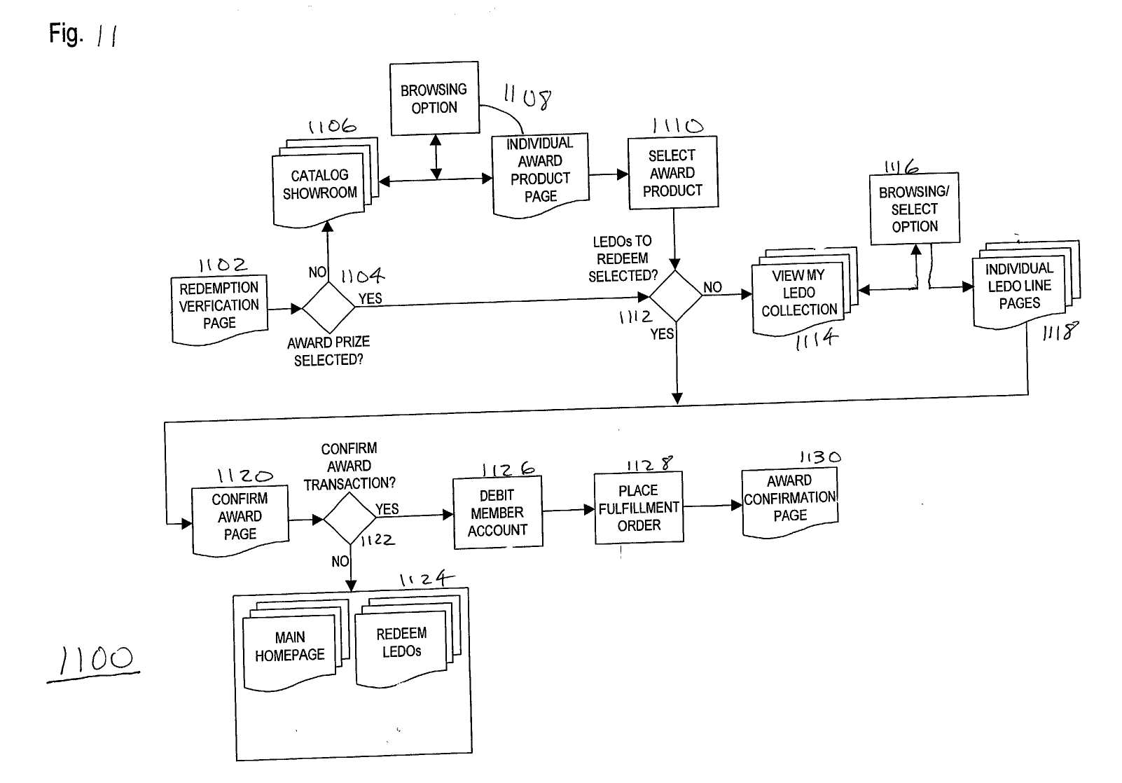

FIG. 10 is a logic flow diagram illustrating a product selection and on-line purchasing process 1000 utilizing an exemplary embodiment of the present invention. In step 1002, a user is transported to a shopping page/portal on the LEDO provider website. In step 1004, the users may use various browsing options to search for and review products and/or services on the LEDO provider website that are available from partner merchants listed within the merchant database. It is anticipated that a user may also be transported directly to a partner merchant's website from the shopping page/portal to browse/shop and/or purchase goods/services. Those skilled in the art will appreciate that this is a relatively conventional approach to online shopping. In step 1006, a user will select an individual product and/or service for purchase. In step 1008, the user will be queried as to whether they wish to continue browsing. If so, the user is returned to step 1002. If not, in step 1010, the user will be queried as to whether they desire to complete their purchase. If not, in step 1012, the user may return to other sections of the LEDO provider website. If so, in step 1014, a query of the merchant database will determine whether the selected product/service is available directly through the LEDO provider website. If not, in step 1026, the user is transported to the website of the appropriate merchant. If the user purchases the selected product/service, in step 1028, the merchant website provides a report/confirmation of the completion of the purchase. In step 1030, this results in the appropriate debiting of the merchant's account in the merchant database and, in step 1031, an award of LEDOs to the purchasing user.

If the product/service is available on the LEDO provider website, in step 1032, the user will be transported to a product order page to place an order. In step 1034, the user will enter order information, comprising such information as user name, address, telephone number, e-mail address, quantity of goods/service, shipping options, method of payment, etc. Those skilled in the art will appreciate that the present invention may be able to insert much of this information automatically for the user from the member database, affording convenience to the user who will have to simply review/confirm the information automatically inserted. In step 1036, the user will be queried to provide a form of payment. If the method of payment is a credit card, in step 1038, such information is entered into the system. In step 1040, if the credit card is electronically approved an order confirmation page will appear in step 1042, confirming for the user the transaction and delivery dates. In step 1044, a fulfillment order will then be placed to either the appropriate merchant or warehouse responsible for the product/service ordered. In step 1046, the merchant or warehouse fulfills the order. In that regard, it is anticipated that there may be instances where it would be advantageous for the LEDO provider to inventory and fulfill certain types of goods and services, but it is expected that goods and services will normally be provided directly from merchants to users, without the LEDO provider ever taking possession of the merchandise. In step 1030, after the fulfillment order is placed, the merchant supplying the goods/services will have their account debited for LEDOs to be awarded to the user. Then, in step 1031, the user will be awarded a number a LEDOs determined by their purchase amount and the LEDO award rate/policy for the given merchant, as recorded in the LEDO provider website's merchant database.

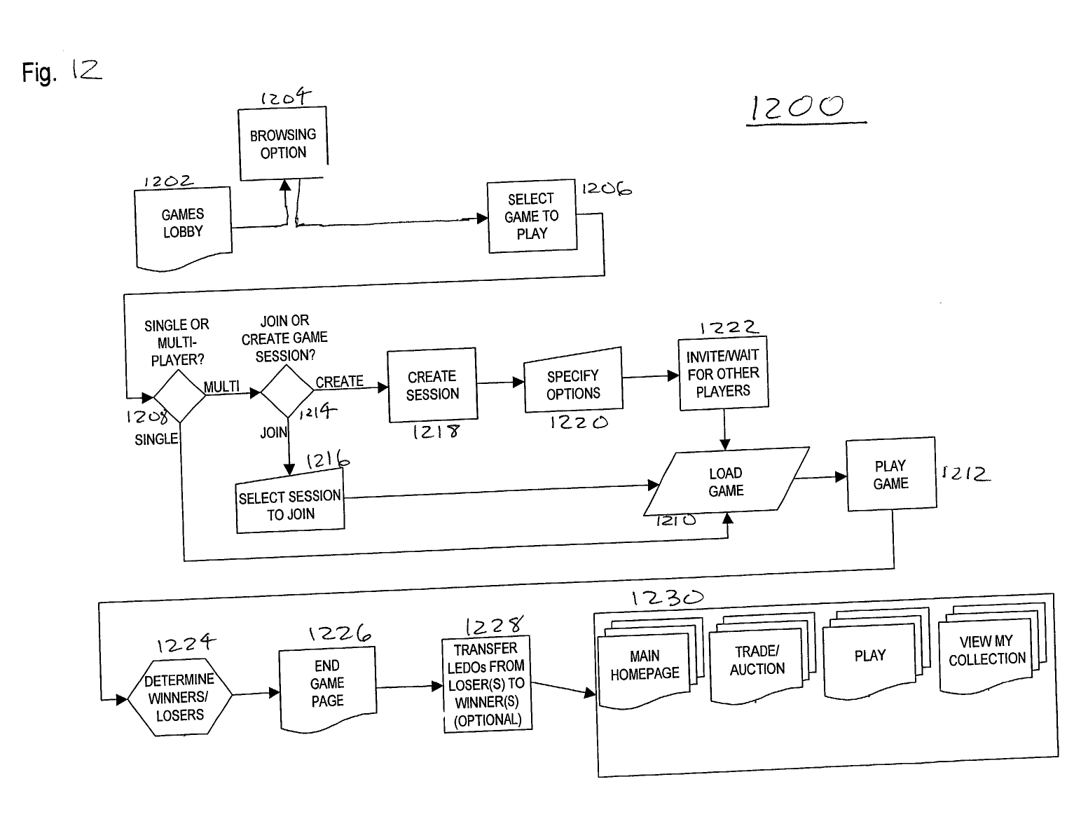

FIG. 11 is a logic flow diagram illustrating a redemption process utilizing an exemplary embodiment of the present invention. In step 1102, a user is transported to a redemption verification page. In step 1104, the system determines whether a redemption award has been selected. If not, in step 1106, the user will be able to access the LEDO provider website's online catalog showroom. In step 1108, the user may browse for the individual redemption award product they wish to select for redemption. In step 1110, the user selects a redemption award product. In step 1112, the system will determine if the proper quantity and denominations of the user's LEDOs have been designated for redemption. If not, in step 1114, the user views their LEDO collection. In step 1116, the user browses through their LEDO content lines. In step 1118, the user selects the individual LEDOs they wish to turn in to redeem for the redemption award they selected.

A key aspect of the this exemplary embodiment of the present invention is that the user will be forced to choose whether or not to trade in LEDOs for redemption awards. If they enjoying owning/collecting/playing with their LEDOs, they may want to keep them rather than exchanging them for redemption awards. Thus, the LEDO provider will be able to lower its operating costs if users are not redeeming their LEDOs for redemption awards.

Once the redemption award and LEDOs selected for redemption have been identified, in step 1120, the user is provided an opportunity to review/confirm the redemption award transaction. In step 1122, the user is queried to confirm the redemption award transaction. If not, in step 1124, the user may return to any other user section of the LEDO provider website, including the main homepage or the redemption verification page.

If so, in step 1126, the user's personal account is debited for the redeemed LEDOs. In step 1128, a fulfillment order is placed for the user so that the prize they selected may be fulfilled, either from an appropriate merchant or warehouse. In step 1130, an award confirmation is sent to the user by the appropriate merchant or warehouse to confirm availability, delivery date, etc. Thereafter, the user may then return to any other user section on the LEDO provider website. In addition to the direct redemption of LEDOs for prizes depicted in FIG. 11, exemplary embodiments of the present invention may also include special, unique prizes that may be auctioned off to users who bid with LEDOs, with the highest bidder(s) winning the prize(s).

It should be noted that the present invention allows merchants to compensate the LEDO provider for LEDOs they wish to award users, in different manners, at a per-LEDO rate previously negotiated between both parties. This payment may either be up-front, where the merchant essentially pre-pays to acquire an inventory of LEDOs, or may take the form, as described in the figures herein, of the merchant paying what is essentially a referral fee for a purchase. In addition, when users trade in LEDOs for redemption prizes, we will compensate the supplying merchant for the good/services provided at an agreed-upon rate.

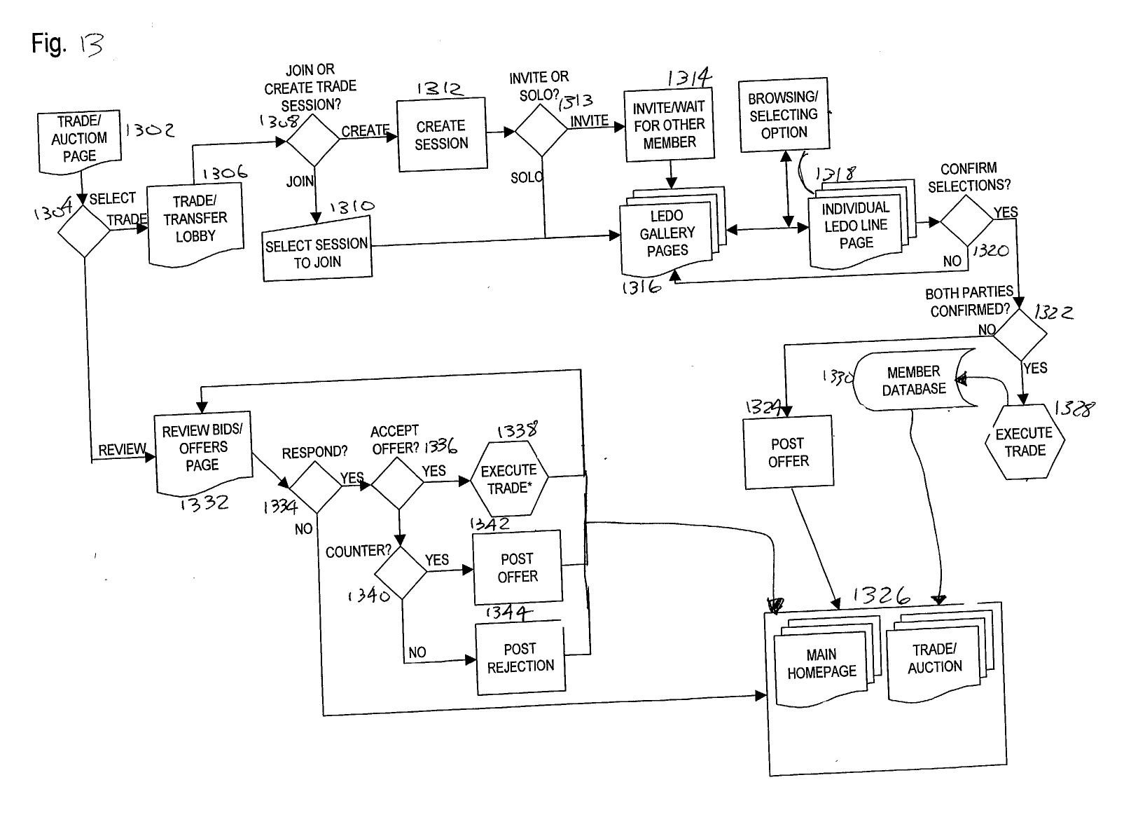

FIG. 12 is a logic flow diagram illustrating an entertainment and on-line gaming process 1200 utilizing an exemplary embodiment of the present invention. In step 1202, the user is transported to a “games lobby” webpage, wherein the user will be able to see information and statistics regarding each of the games/activities associated with the exemplary embodiment, and the number, IDs, and status of other users, to include listings of who is on-line, what game/lobby they are located in, what their game “rankings” are with respect to various games/activities, etc. In step 1204, the user will be able to browse through individual game lobbies, with their access either restricted or enhanced based on information from the member database (e.g., the user's specific LEDO collections, additional memberships they have paid for to play certain games, icons and privileges earned and thus usable within particular games/game lobbies, etc.).

It should be noted that the term “game” is used to denote both games and other types of activities (chat rooms, virtual reality sites, simulators, level/scenario/game editors/creators, online crafts, etc.) that users can access. The common element of each of these activities/games is that they are tied to the use of LEDOs and that the LEDOs in a user's collection will affect their experience within each of these “games”. For simplicity, the term “game” will be used to refer to these activities.

In step 1206, the user selects a game to play. In step 1208, the system conducts a query to determine whether the selected game is a single or multi-player game. If it is a single player game, in step 1210, the system will load the game, and allow the user to play the game in step 1212. It should be noted that there are a variety of ways that the game loading function can be technically implemented, either as browser plug-in technology, the opening of an application that the user received with one of their LEDOs collector's albums, or through other means.

If the user has selected a multi-player game, in step 1214, they will have the option to either join or create a game session. If the user joins an ongoing game, in step 1216, they will have to select which session to join, load the game in step 1210, and once the appropriate numbers of players have joined, as determined by the creator of the game session, they will play the game in step 1212. If the user chooses to create a session, in step 1218, they will have to specify options, in step 1220, regarding the game, comprising how it will be played, what are the effects of winning/losing, and what type of other members will be allowed to play. With their game session set up, in step 1222, the user will then have to invite other members to play and/or wait for other players to join. Once enough other members have, joined, the game will be loaded by the players in step 1210 and played in step 1212.

At the conclusion of the game, in step 1224, the system will determine who the winners and losers of the game are, if any. In step 1226, the system will post to each player an “end of game” page describing who won, who lost, and the consequences of winning/losing, which can include such things as advancement in a tournament, a change in a user's ranking, and/or the loss or winning of LEDOs. If the game or the session options specify that the game's winners will win some LEDOs from the losers, then, in step 1228, the system will transfer LEDOs from loser(s) to winner(s). In step 1230, the user will have the option to either return to other sections of the LEDO provider webpage, play the game again, etc.

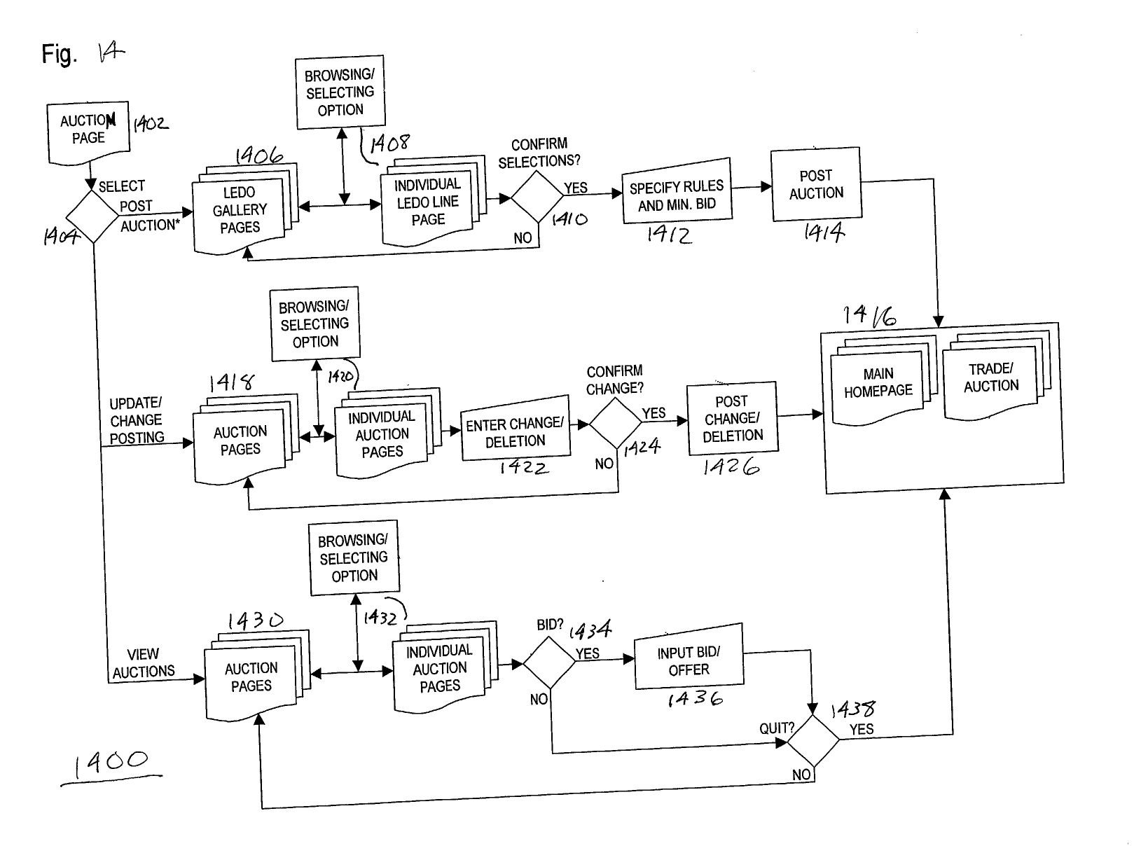

FIG. 13 is a logic flow diagram illustrating a trading/auction process 1300 utilizing an exemplary embodiment of the present invention. In step 1302, a user is transported to a trade/auction webpage. In step 1304, the user will have the option to select to go to a trade/transfer lobby, a review bids/offers webpage, or go to an auction webpage. In step 1306, from the trade/transfer lobby, the user will be able to chat with other users, if desired, and will be able to propose/respond to offers to trade LEDOs.

In step 1308, the user will have the option to join or create a trading session. If they choose to join a session, in step 1310, they will have to select a session to join, which will typically have just been created by another user with whom they have been chatting. If instead, the user chooses to create a session, in step 1312 he will have the choice to invite another member or to proceed solo in step 1313. If they decide to invite another user, is step 1314, they will have to wait for the other user to accept their invitation.

Whether joining a session, or creating a session for one or more users, the user will then have to go to LEDO gallery pages, in step 1316, which will provide the functionality so that, in step 1318, they can browse through and select the LEDOs they wish to trade from individual LEDO content lines, in step 1318, as well as see what LEDOs the other member wishes to trade. It is anticipated that chat sessions will be enabled, allowing users to continue discussing their trade. In addition to trading LEDOs, users will be able to buy/sell LEDOs on a cash basis, which will either be handled offline (e.g., checks, money orders, etc.), or directly through the online system (e.g., account/credit card debits in the member database, etc.).

If a user is proceeding on a solo basis, then they will not experience most of the functionality of this process. In essence, the user will be outlining a proposed trade to another member, specify which LEDOs they are prepared to trade, which LEDOs they expect in return, and any cash component to the trade. For proposed trades made on a solo basis, once the user confirms their selections, in step 1320, the trade will not be executed immediately, as a second party has not confirmed the trade, based on the query conducted in step 1322. Instead, the solo user's offer will be posted to the other member, in step 1324, through the member database, who may review the offer in the future and either accept it, counter it, or reject the offer. Upon completion of the posting, in step 1326, the user will have the option to return to the other sections of the LEDO provider website, including the main homepage or to the trade/auction webpage.

If two (or more) members are conducting a trade in the same session, once they both parties have confirm their selections, in step 1322, the system will execute the trade, in step 1328, posting the change of ownership of the relevant LEDOs (and optionally money) to the member database, in step 1330. With the trade consummated, the user may return to the main homepage or return to the trade/auction page in step 1326.

If instead the user selected to review bids/offers, in step 1332, the user will be brought to a “review bids/offers” webpage where the user will be able to review all outstanding offers to trade they have received from other members, to review any final bids that others have placed in LEDO auctions they are conducting, to review updates on the status of bids they have made in other members' auctions, and to review non-final bids for their own auctions. After reviewing the various bids, offers, and updates, in step 1334, the user can choose to respond to any of the offers/final bids. If they do respond, in step 1336, they can accept the offer (or confirm the bid, if this is not done automatically by the auction), in which case that will execute the trade/bid, in step 1338, and post the change of ownership of LEDOs/money to the member database. If the user is not satisfied with the offer/bid, they can choose whether or not to counter, in step 1340, with the system posting either the counter offer, in step 1342, or the rejection to the other member, in step 1344, via the member database, which they will be able to review in the future when they choose to go to the review bids/offers page. Once through with the review process, in step 1326, the user will have the option to return to other sections of the LEDO provider website, including the main homepage or the trade/auction page.

FIG. 14 is a logic flow diagram illustrating an additional auction process 1400 utilizing an exemplary embodiment of the present invention. In step 1402, the user is transported to an auction page. In step 1404, the user may select whether they wish to post an auction (or classified ad), update/change a previous posting they created, or to view auctions (and classified ads). It should be noted that for the remainder of this description, the term “auction” will be used to refer to both auctions and classified ads.

If the user selects to post an auction, in step 1406, they will be transported to LEDO gallery webpages where, in step 1408, they will be able to browse through and select LEDOs from their collection (as listed in the member database and displayed on individual LEDO content line webpages) to offer for their auction. Once the user confirms their selections of LEDOs to auction, in step 1410, they will be able to specify auction rules and minimum bids, in step 1412, and then the system will post the auction/classified ad to the member database, in step 1414, making it available for other users who are viewing auctions. Thereafter, in step 1416, the user can return to others sections within the LEDO provider website, including the main homepage or to trade/auction webpage.

If the user selects to update/change a posting, in step 1418, they will be transported to auction pages where they will be able to browse through individual auction pages, in step 1420, until they find the one they wish to update/change. In step 1422, the user may enter the changes they wish to make and/or delete the auction. If the user confirms the change in step 1424, the system will post the change/deletion to the member database, in step 1426, and the user, in step 1416, may return to the other sections of the LEDO provider website, including the main homepage or the trade/auction webpage.

If the user selects to view auctions, in step 1430, they will be transported to auction pages where, in step 1432, they may browse/select through the individual auction pages. In step 1436, they will then have the choice to bid on a selected auction, inputting a bid/offer in step 1436, that is posted to the member database, or quitting the process in step 1438. They may then stop looking at auctions and proceed to step 1416, or to continue and return to step 1430.

What is claimed is:

1. A method for providing an on-line digital collectibles redemption system, comprising:
attracting users to an first on-line location that provides information which appeals to the personal interests of the users;
in response to the selection of a link at the first said on-line location, transporting said users to a second on-line location for the distribution of digital collectibles;
in response to the selection of a link at the second said on-line location, transporting said users to a third on-line location that provides on-line commercial transaction opportunities for said users;
in response to said users' completion of on-line commercial transactions at the third said on-line location, rewarding said users with digital collectibles; and
allowing said users to redeem said digital collectibles for value.

2. The method of claim 1, wherein the on-line digital collectible location further allows users to engage in at least one of the activities of trading or auctioning digital collectibles.

3. The method of claim 1, wherein the on-line digital collectible location further allows users to engage in games involving digital collectibles.

4. The method of claim 3, wherein said games further comprise at least one of instant-wins games, sweepstakes games or lottery games.

5. The method of claim 1, wherein the on-line digital collectible location further comprises a location that allows users to interact with digital collectibles.

6. The method of claim 1, further comprising the step of allowing for the compensation of entities recruit users for participation in the distribution of digital collectibles.

7. The method of claim 6, further comprising the step of allowing for the multi-level compensation of entities that recruit users for participation in the distribution of digital collectibles.

8. The method of claim 1, wherein said on-line commercial transaction opportunities comprise the on-line purchase of goods and services.

9. The method of claim 1, wherein said on-line commercial transaction opportunities comprise the participation by users in desirable consumer behavior comprising at least one of recruiting other users for participation in the distribution of digital collectibles, completing on-line surveys, registering for on-line memberships or registering for on-line subscriptions.

10. The method of claim 1, wherein said redemption of digital collectibles comprises at least one of the activities of redeeming digital collectibles for merchandise, for services, for monetary value or for additional digital collectibles.

11. A fully-integrated, on-line digital collectible redemption system, comprising:
an first on-line location that provides information that appeals to the interests of on-line users;
a second on-line location for the distribution and redemption of digital collectibles to users that have visited the first said on-line location; and
a third on-line location that provides on-line commercial transaction opportunities that, when said on-line transaction opportunities are completed, result in a reward of digital collectibles by the second said on-line location.
